(19) United States
(12) Patent Application Publication
(10) Pub. No.: US 2020/0207179 A1
(43) Pub. Date: Jul. 2, 2020

(54) AIR CONDITIONER FOR VEHICLE

(71) Applicant: Hanon Systems, Daejeon (KR)

(72) Inventors: Seong Seok HAN, Daejeon (KR); Sung Ho KANG, Daejeon (KR); Jeong Jae LEE, Daejeon (KR); Boo Yong UM, Daejeon (KR); Jung Won CHO, Daejeon (KR)

(21) Appl. No.: 16/634,437

(22) PCT Filed: Sep. 10, 2018
(86) PCT No.: PCT/KR2018/010564

§ 371 Date: Jan. 27, 2020

(30) Foreign Application Priority Data
Sep. 14, 2017 (KR) 10-2017-0118041

(51) Int. Cl. B60H 1/00; B60H 1/32

(52) U.S. Cl. CPC B60H 1/00028; B60H 1/3233; B60H 1/00671; B60H 2001/00242; B60H 1/00564; B60H 1/00207; B60H 1/00885

(57) ABSTRACT

Disclosed is an air conditioner for a vehicle. The air conditioner includes a blower unit having an air blower which is erect, wherein the blower unit is arranged between an evaporator unit having an evaporator and a heater unit having a heater core in order to remarkably reduce the width of the air conditioner and maximize an internal space of the vehicle.

### TECHNICAL FIELD

The present invention relates to an air conditioner for a vehicle, and more particularly, to an air conditioner for a vehicle, which includes a blower arranged between an evaporator and a heater core in order to maximize an internal space of the vehicle.

### BACKGROUND ART

In general, an air conditioner for a vehicle is an apparatus for cooling or heating the interior of the vehicle by cooling or heating through the process of introducing outdoor air into the interior of the vehicle or circulating indoor air of the vehicle. Such an air conditioner for a vehicle includes an evaporator for cooling the inside of an air-conditioning case; a heater core for heating the inside of the air-conditioning case; and a mode converting door for selectively blowing the air cooled by the evaporator or heated by the heater core toward parts of the interior of the vehicle.

According to mounted structures of an air blower unit, an evaporator unit and a heater core unit, such an air conditioner is classified into a three-piece type air conditioner where the air blower unit, the evaporator unit, and the heater core unit are disposed independently, a semi-center type air conditioner where the evaporator unit and the heater core unit are embedded in an air conditioning case and the air blower unit is mounted separately, and a center-mounting type air conditioner where the three units are all embedded in the air conditioning case.

FIG. 1 is a conceptual diagram of a conventional air conditioner for a vehicle. As shown in the drawing, the conventional air conditioner includes: a blower unit 10 including an indoor air inlet 21 and an outdoor air inlet 22, which are formed at one side, an indoor and outdoor air converting door 23 mounted to selectively open and close the indoor air inlet 21 and the outdoor air inlet 22, and a blast fan 35 for forcedly blowing indoor air and outdoor air toward an air inlet 43 of an air-conditioning case 40; and the air-conditioning case 40 having the air inlet 43 for introducing the air blown from the blower unit 10, an air outlet 44 for discharging the air, and an evaporator 41 and a heater core 42 mounted in the air-conditioning case 40 to be spaced apart from each other at a predetermined interval.

Here, the indoor and outdoor air converting door 23 may adopt one of various types, such as a plate type, a dome type which is under little pressure of air, a cylindrical type, and a hemispherical type.

FIG. 2 is a perspective view showing a semi center type air conditioner among the conventional air conditioners. The air conditioner 1 includes: an air-conditioning case 40 having an air inlet 43 formed at an entrance and a plurality of air outlets 44 formed at an exit; and a blower unit 10 for selectively introducing indoor air and outdoor air through an indoor air inlet and an outdoor air inlet 22 formed at an upper part thereof to forcedly blow the air toward the air inlet 43.

The air-conditioning case 40 includes an upper case formed by assembly of a left case and a right case and a lower case assembled to the bottom of the upper case.

Moreover, an evaporator 41 and a heater core (not shown) are mounted inside the air-conditioning case 40 in order, and a temperature adjusting door (not shown) for adjusting temperature and mode doors (not shown) for carrying out various air-conditioning modes are mounted inside the air-conditioning case 40.

Furthermore, the indoor and outdoor air inlets 21 and 22 are communicated with the air inlet 43 of the air-conditioning case 40, and the blast fan 35 is disposed below the indoor and outdoor air inlets 21 and 22. In this instance, the air inlet 43 is formed on the side surface of the air-conditioning case 40.

That is, the blast fan 35 forcedly blows the air introduced from the indoor and outdoor air inlets 21 and 22 to the air inlet 43 formed on the latera surface of the air-conditioning case 40 by rotation. In this instance, a passageway of the air is formed in such a way that the air introduced into the indoor and outdoor air inlets 21 and 22 flows downwardly, passes through the blast fan 35, and is introduced into the air inlet 43 formed on the side surface of the air-conditioning case 40 by rotation of the blast fan 35. That is, the blast fan 35 is disposed below the indoor and outdoor air inlets 21 and 22, and the air-conditioning case 40 is disposed next to the blower unit 10 to communicate with the blower unit 10.

According to the air conditioner 1, the air blown to the inside of the air-conditioning case 40 by operation of the blower unit 10 passes the evaporator 41, and is cooled or heated while selectively passing the heater core 42 by the temperature adjusting door. As described above, the cooled or heated air is supplied to the interior of the vehicle through ducts (not shown) connected with a plurality of air outlets 44 to cool or heat the interior of the vehicle.

However, like the semi-center type air conditioner 1, if the blast fan 35 is formed at a lower portion of the blower unit 10 to lie on the lower surface, the width of the air conditioner 1 increases, and the internal space of the vehicle may be relatively reduced.

Moreover, because the air passing through the blast fan 35 passes through the evaporator 41 and the heater core 42 in order, the evaporator 41 directly touches the blast fan 35. However, the heater core 42 is relatively far away from the blast fan 35 since the air passes through the heater core 42 after passing through the evaporator 41, so it is not easy to control an air volume.

Now, development for reducing the size of the air conditioner is ongoing actively, but in the conventional arrangement of the semi-center type air conditioner 1 and parts, because the blast fan 35 lies in the whole length direction of the vehicle and the evaporator 41 and the heater core 42 are also arranged side by side in the whole length direction of the vehicle, the conventional air conditioner has a disadvantage in that it occupies a wide space.

### DISCLOSURE

### Technical Problem

Accordingly, the present invention has been made in view of the above-mentioned problems occurring in the prior art, and it is an object of the present invention to provide an air conditioner for a vehicle, which includes a blower unit having an air blower which is erect, wherein the blower unit is arranged between an evaporator unit having an evaporator and a heater unit having a heater core in order to remarkably reduce the width of the air conditioner and maximize an internal space of the vehicle.

### Technical Solution

To accomplish the above object, according to the present invention, there is provided an air conditioner for a vehicle, which has a cooling heat exchanger, a blower, and a heating heat exchanger, wherein a dash panel of the vehicle and the cooling heat exchanger are arranged parallel with each other to face each other.

Moreover, the cooling heat exchanger, the blower, and the heating heat exchanger are arranged in order in a width direction of the vehicle, and are arranged parallel with the dash panel of the vehicle.

Furthermore, the air conditioner for a vehicle according to the present invention further includes: an evaporator unit having an air inlet, wherein the cooling heat exchanger is disposed therein; a blower unit communicating with the evaporator unit and having the blower therein; and a heater unit communicating with the blower unit and having an air outlet formed at one side thereof, wherein the heating heat exchanger is disposed therein, wherein air introduced into the air inlet passes through the cooling heat exchanger, the blower and the heater core in order, and then, is discharged to the air outlet.

Additionally, the air inlet includes an indoor air inlet which is an inlet for inhaling indoor air of the vehicle and an outdoor air inlet which is an inlet for inhaling outdoor air of the vehicle, and the evaporator unit includes an indoor and outdoor air door for selectively introducing the indoor air or the outdoor air of the vehicle.

In addition, a condensate water drain is disposed inside the evaporator unit in order to drain condensate water dropping from the evaporator.

Moreover, the blower unit is arranged between the evaporator unit and the heater unit, and a rotary shaft of the blower is arranged in a back-and-forth direction of the vehicle.

Furthermore, the heater unit includes: an air-conditioning case having an air passageway communicating with the air outlet; the heating heat exchanger mounted in the air passageway of the air-conditioning case; and a temperature-adjusting door mounted at one side of the heating heat exchanger in order to adjust the degree of opening of the passageway passing the heater core.

Additionally, the air conditioner for a vehicle according to the present invention further includes a rear vent for discharging air to the rear seat of the vehicle, and the evaporator unit includes a second outlet communicating with the rear vent.

In addition, the second outlet is formed at a lower side of the first outlet.

Moreover, the rear vent communicating with the second outlet is arranged at a lower side of the heater unit.

Furthermore, a rear seat door is disposed at the second outlet to open or close the second outlet.

### Advantageous Effects

As described above, the air conditioner for a vehicle according to an embodiment of the present invention can directly control an amount of air passing through the evaporator and the heater core since the blower is arranged between the evaporator and the heater core.

Additionally, the evaporator and the heater core are individually arranged in different units to be erect and the blast fan of the blower is arranged to be erect. Therefore, the air conditioner for a vehicle according to the present invention can maximize the internal space of the vehicle since the width that the air conditioner occupies is reduced remarkably in comparison with the conventional air conditioner including the blast fan arranged to lie.

In addition, the air conditioner for a vehicle according to the present invention can minimize thermal losses since the evaporator and the heater core are individually arranged in different units, and can easily control the amount of air supplied to the heater core since the heater core directly communicates with the blast fan.

### DESCRIPTION OF DRAWINGS

FIG. 1 is a conceptual diagram of a conventional air conditioner for a vehicle.

FIG. 2 is a perspective view showing the conventional air conditioner for a vehicle.

FIGS. 3 to 6 are perspective views showing an air conditioner for a vehicle according to the present invention.

FIGS. 7 and 8 are perspective view showing a right side view and a left side view that the air conditioner for a vehicle according to the present invention and the conventional air conditioner for a vehicle are compared with each other, wherein FIG. 7 is a side view of a heater unit of the air conditioner for a vehicle, and FIG. 8 is a side view of an evaporator unit.

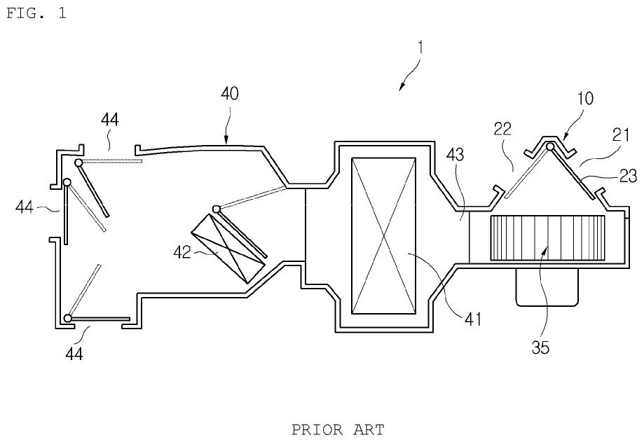

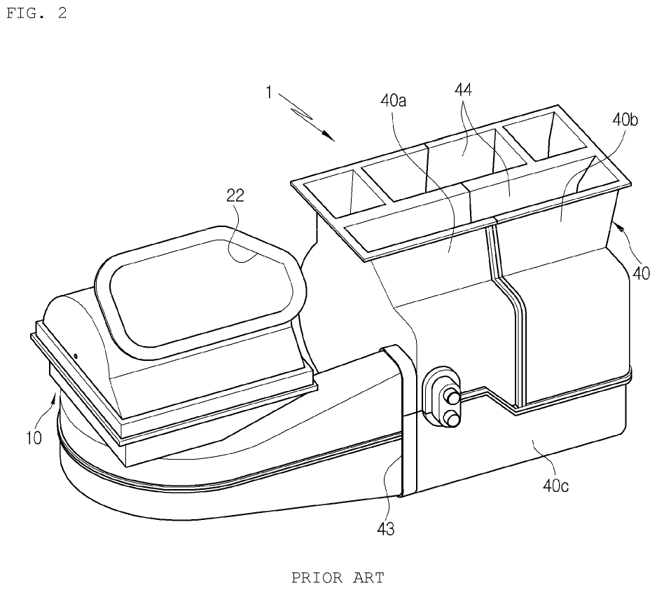

### MODE FOR INVENTION

In order to fully understand the present invention, exemplary embodiments of the invention will be described with reference to the accompanying drawings. The embodiments of the present invention may be modified in many different forms and the scope of the invention should not be limited to the embodiments set forth herein. Rather, these embodiments are provided so that this disclosure will be thorough and complete, and will fully convey the concept of the invention to those skilled in the art. In the drawings, the shapes and dimensions may be exaggerated for clarity, and the same reference numerals will be used throughout to designate the same or like components. A detailed explanation of known related functions and constitutions may be omitted to avoid unnecessarily obscuring the subject matter of the present invention.

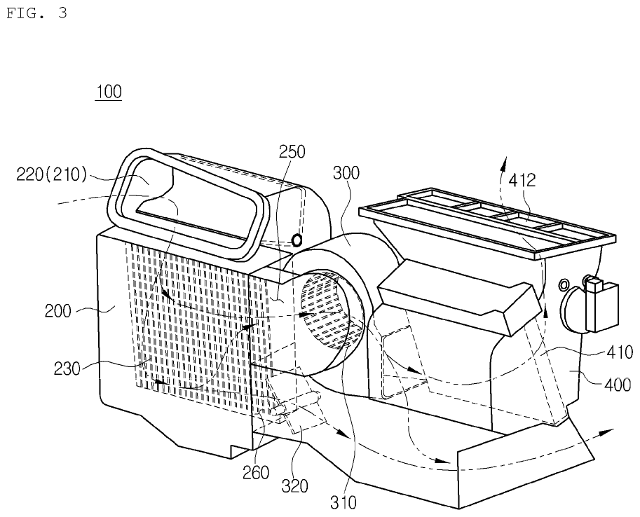

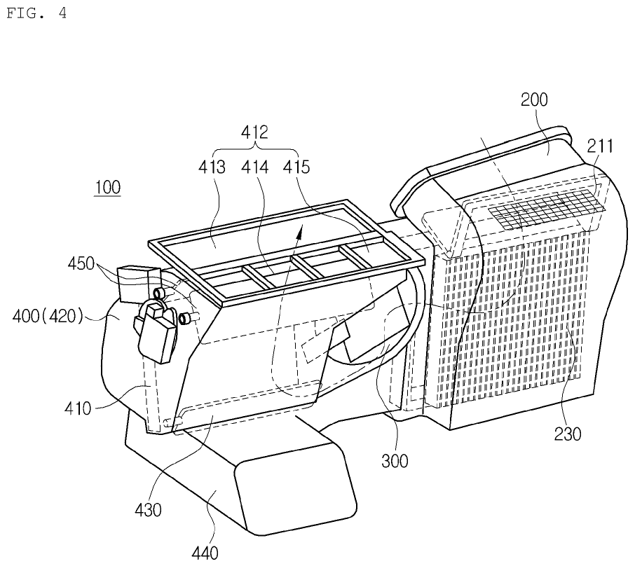

FIGS. 3 to 6 are perspective views showing an air conditioner for a vehicle according to the present invention.

As shown in FIGS. 3 to 6, the air conditioner 100 for a vehicle according to the preferred embodiment of the present invention includes: an evaporator unit 200, which includes an air inlet 220 having an indoor air inlet 210 and an outdoor air inlet 211 and an evaporator 230 disposed in the evaporator unit 200; a blower unit 300 communicating with the evaporator unit 200 and having an air blower 310 disposed therein; a heater unit 400 communicating with the blower unit 300 and including a heater core 410 disposed therein and an air discharge port 412 for discharging the air passing the heater core 410. In this instance, the evaporator unit 200, the blower unit 300 and the heater unit 400 are combined and communicated with one another in order.

The evaporator 230 applied to the air conditioner 100 for a vehicle according to the present invention may be an evaporator by circulation of refrigerant or a cooling heat exchanger, and the heater core 410 may be a heat exchanger by circulation of coolant or a heating heat exchanger for absorbing waste heat of electronic parts. Hereinafter, for your understanding, the evaporator 230 and the heater core 410 will be described.

That is, the air conditioner for a vehicle according to the present invention is different from the conventional air conditioner that indoor air or outdoor air passes through the blower 310, the evaporator 230 and the heater core 410 in order and is discharged to the interior of the vehicle. The air conditioner for a vehicle according to the present invention is characterized in that the blower 310 is arranged between the evaporator 230 and the heater core 410 so that indoor air or outdoor air passes through the evaporator 230, the blower 310 and the heater core 410 in order.

Therefore, the evaporator 230 and the heater core 410 are not arranged side by side in one unit, namely, an air-conditioning case to occupy wide width and space, but because the evaporator 230 is arranged in the evaporator unit 200 and the heater core 410 is arranged in the heater unit 400, the air conditioner 100 for a vehicle according to the present invention can remarkably reduce the volume of the air conditioner 100 so as to utilize the interior space of the vehicle.

Moreover, the conventional air conditioner has the disadvantage in that it is difficult to directly control the amount of air introduced into the heater core 410 since the air passing the evaporator 230 by the blower 310 passes through the heater core 410. However, the air conditioner for a vehicle according to the present invention can directly control the amount of air passing through the evaporator 230 and the heater core 410 since the blower 310 is arranged between the evaporator 230 and the heater core 410.

Furthermore, the air conditioner for a vehicle can maximize the internal space of the vehicle since a dash panel of the vehicle and the evaporator 230 of the evaporator unit 200 are arranged parallel with each other to face each other. In addition to the arrangement of the evaporator 230 of the evaporator unit 200, because the blower 310 of the blower unit 300 and the heater core 410 of the heater unit 400 are arranged parallel with the dash panel to face the dash panel of the vehicle according to the width of the vehicle, the air conditioner for a vehicle according to the present invention can secure the interior space of the vehicle more.

That is, the evaporator unit 200, the blower unit 300 and the heater unit 400 are arranged in order according to the width of the dash panel in a width direction of the vehicle. Such a structure is suitable for an autonomous vehicle requiring a wide front seat space, and can provide a wide interior space since a heating sheet is rotated or moved to face a rear side. That is, the volume of the air conditioner must be reduced in order to secure the interior space of the vehicle.

Additionally, even though the volume of the air conditioner is reduced, because the above-mentioned structure can individually perform various air-conditioning functions, such as temperature adjustment, cooling and heating modes, air volume control, and so on in various areas, it can maximize its effect especially in the autonomous vehicle.

Hereinafter, the structure of the air conditioner 100 for a vehicle according to the present invention will be described in detail.

First, the evaporator unit 200 includes the evaporator 230 arranged therein, the air inlet 220 having the indoor air inlet 210, which is an inlet formed at one side to inhale indoor air of the vehicle, or the outdoor air inlet 211, which is an inlet to inhale outdoor air of the vehicle, and an indoor and outdoor air door 240 disposed at one side of the air inlet 220 to selectively introduce indoor air or outdoor air.

In this instance, the evaporator unit 200 may include: a first outlet 250 communicating with the blower unit 300; and a second outlet 260 communicating with a rear vent 440. The second outlet 260 is formed at a lower end of the first outlet 250 and communicates with the rear vent 440, and the rear vent 440 is formed at a lower side of the heater unit 400, which will be described later. Therefore, the width of the air conditioner 100 for a vehicle can be reduced. A rear seat door 320 may be disposed at the second outlet 260 to open or close the second outlet 260.

Because the evaporator 230 is arranged inside the evaporator unit 200, a condensate water outlet (not shown) may be disposed at the bottom of the evaporator unit 200 in order to prevent leakage of condensate water dropping from the evaporator 230 and to smoothly drain the condensate water to the outside.

Moreover, because the evaporator 230 stands vertically inside the evaporator unit 200, the entire thickness of the air conditioner 100 may be reduced. Finally, it widens the interior space of the vehicle.

The blower unit 300 has the air blower 310 disposed therein, and blows the air introduced into the first outlet of the evaporator unit 200 to the heater unit 400. In this instance, an amount of air blown to the heater unit 400 may be directly controlled by a control unit (not shown).

The blower 310 of the blower unit 300 includes a scroll case which has a blast fan communicating with the first outlet 250 of the evaporator unit 200 to forcibly blow air toward the heater unit 400. That is, the blower 310 has the known structure, but is arranged between the evaporator unit 200 and the heater unit 400 to stand vertically in the air conditioner 100 according to the present invention.

In this instance, the blower 310 has the known structure, and includes the blast fan and the scroll case surrounding the blast fan. In the meantime, the conventional air conditioner is increased in the entire width since the rotary shaft of the blast fan is arranged vertically and the blast fan is assembled to lie horizontally. However, because a rotary shaft of the blast fan of the blower 310 according to the present invention is arranged in the back-and-forth direction of the air conditioner 100, namely, the blast fan stands vertically, the width of the air conditioner 100 can be reduced.

In detail, like the arrangement of the evaporator 230 in the evaporator unit 200, because the blower 310 stands vertically inside the blower unit 300, the entire thickness of the air conditioner 100 can be reduced, and such arrangements of the evaporator 230 and the blower 310 can widen the interior space of the vehicle.

Furthermore, the conventional air conditioner is enlarged in width since the evaporator 230 and the heater core 410 are arranged in one unit to be spaced apart from each other. However, the air conditioner 100 according to the present invention can remarkably reduce its width since the evaporator 230 and the heater core 410 are arranged in different units to stand vertically and the blast fan also stands vertically inside the blower unit 300.

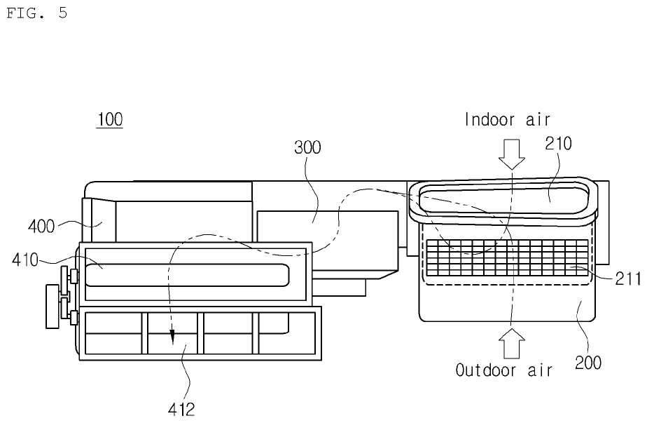

Therefore, as shown in FIG. 5, because the blower 310 stands vertically in the blower unit 300, the air supplied from the first outlet 250 is introduced at 90 angles, and then, flows toward the heater unit 400 at 90 angles. In this instance, the indoor air introduced through the indoor air inlet 210 is supplied to the first outlet 250 after passing through the evaporator 230, or the outdoor air introduced through the outdoor air inlet 211 is supplied to the first outlet 250 after passing through the evaporator 230.

The heater unit 400 communicates with the blower unit 300 so that the indoor air or outdoor air controlled in the air volume is introduced from the blower 310. That is, the heater unit 400 includes: an air-conditioning case 420 having an air discharge port 412 formed at one side and an air passageway formed therein to communicate with the air outlet 412; the heater core 410 mounted in the air passageway of the air-conditioning case 420; and a temperature-adjusting door 430 mounted at one side of the heater core 410 to adjust the degree of opening of the passageway passing the heater core 410.

In this instance, the air outlet 412 includes a defrost vent 413, a face vent 414, and a floor vent 415, and the air blown from the blower unit 300 is discharged to the vents 413, 414 and 415 after selectively passing the heater core 410 by the temperature-adjusting door 430. Furthermore, a plurality of mode doors 450 are mounted at sides of the vents 413, 414 and 415 to determine an air discharge amount to each vent or to selectively distribute the air discharge amount.

As shown in FIG. 5, the indoor air introduced into the indoor air inlet 210 is introduced into the first outlet 250 or the second outlet 260 after passing the evaporator 230 from the front to the rear, and the outdoor air introduced into the outdoor air inlet 211 is introduced into the first outlet 250 or the second outlet 260 after passing the evaporator 230 from the rear to the front.

In this embodiment of the present invention, the rear vent 440 communicating with the second outlet 260 of the evaporator unit 200 communicates with a rear discharge pipe (not shown) for discharge air to the rear seat of the vehicle. Referring to FIG. 3, the indoor air or the outdoor air passing the evaporator 230 and the first outlet 250 by the blower 310 of the blower unit 300 does not pass the heater core 410 but is directly discharged to the rear vent 440. In this instance, a rear seat heater unit may be disposed at one side of the rear vent 440 to communicate with the rear vent 440. The rear seat door 320 disposed at the second outlet 260 closes the second outlet 260, and the air, which passed the first outlet 250, is blown to the rear vent 440 by the blower 310.

That is, the air conditioner according to the present invention has the structure to blow air toward the front seat and the rear seat by the blower 310 of the blower unit 300. Such a structure is especially suitable for autonomous vehicles, and can secure a wide interior space since having just one blower to blow air to all of the front seat and the rear seat.

In order to reduce the width of the air conditioner 100 for a vehicle according to the present invention, the first outlet 250 and the second outlet 260 formed in the evaporator unit 200 are formed vertically, and preferably, the second outlet 260 is formed at the lower side of the first outlet 250. Additionally, the rear vent 440 communicating with the second outlet 260 is formed at the lower side of the heater unit 400 to remarkably reduce the width of the air conditioner 100.

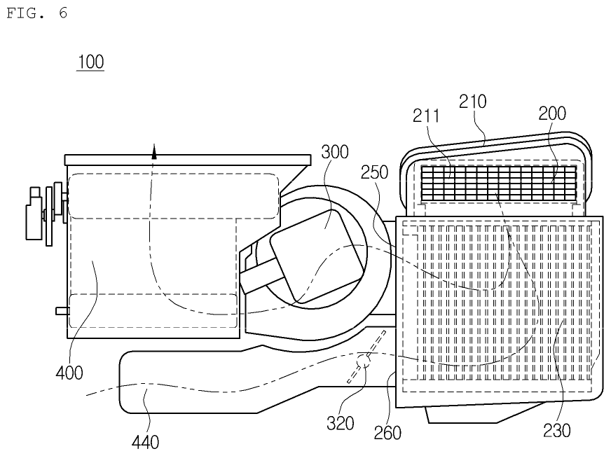

In another embodiment, as shown in FIG. 6, the indoor air or the outdoor air passing through the second outlet 260 without passing through the blower 310 of the blower unit 300 may be directly discharged to the rear vent 440. In this instance, another blower fan and a heating heat exchanger (including a heater core) may be additionally disposed at one side of the rear vent 440. The blower unit 300 may blow air to the rear vent 440, but in case of a vehicle which has lots of wind to be discharged to the rear seat or if it is necessary to accurately control an amount of air to be discharged to the rear seat, it may be considered to mount an additional blast fan at the rear vent 440.

That is, such a structure can not only secure a maximized interior space of the vehicle but also blow air to all of the front seat and the rear seat by the blower unit 300, or can accurately control an amount of cold air or warm air due to the blast fan and the heater core additionally disposed at the rear vent 440.

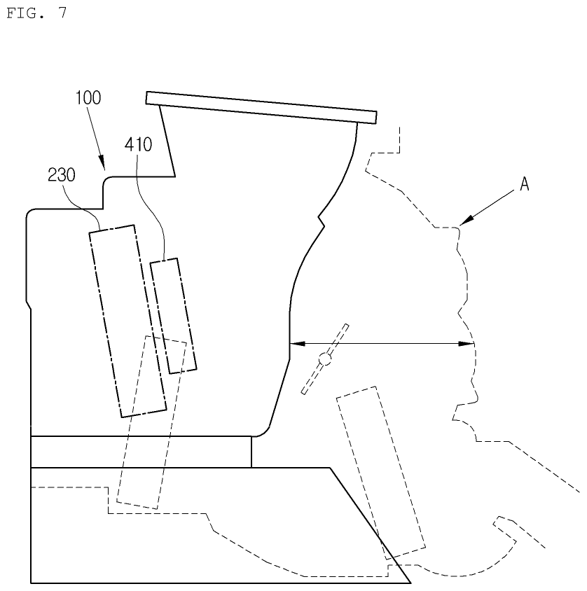

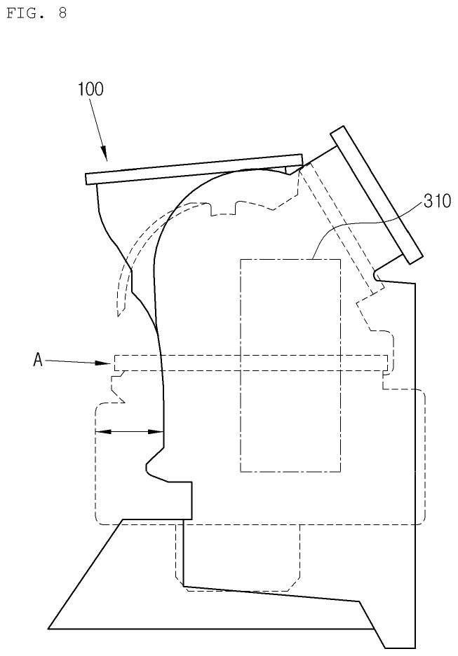

FIGS. 7 and 8 are perspective view showing a right side view and a left side view that the air conditioner for a vehicle according to the present invention and the conventional air conditioner for a vehicle are compared with each other, wherein FIG. 7 is a side view of the heater unit 400 of the air conditioner 100 for a vehicle, and FIG. 8 is a side view of the evaporator unit 200. In FIGS. 7 and 8, the air conditioner according to the present invention is indicated by a solid line and a broken line, and the conventional air conditioner is indicated by a dotted line (A).

As shown in FIG. 7, the air conditioner 100 for a vehicle according to the present invention that the evaporator 230 and the heater core 410 are respectively arranged in different units to stand vertically is ⅔ times smaller in width than the conventional air conditioner that the evaporator and the heater core are arranged together in one unit.

As shown in FIG. 8, the air conditioner 100 for a vehicle according to the present invention that the evaporator 230 and the heater core 410 are respectively arranged in different units to stand vertically and the blast fan of the blower 310 is also arranged to stand vertically is ⅔ times smaller in width of the relevant part than the conventional air conditioner that the blast fan is arranged to lie horizontally. Therefore, the air conditioner 100 for a vehicle according to the present invention can maximize the interior space of the vehicle.

Moreover, because the evaporator 230 and the heater core 410 are respectively arranged in different units, the air conditioner 100 for a vehicle according to the present invention can minimize thermal losses and can easily control the amount of air supplied to the heater core 410 since the heater core 410 directly communicates with the blast fan.

Hereinafter, actions of the air conditioner 100 for a vehicle according to the present invention will be described.

First, when the blower 310 of the blower unit 300 of the air conditioner 100 operates, the air inhaled into the air inlet 220 of the evaporator unit 200 passes through the evaporator 230, and then, reaches the blower 310 through the first outlet 250.

The air reaching the blower 310 bypasses or passes the heater core 410 by the temperature-adjusting door 430. In this instance, in a cooling mode, the air changed into cold air while passing through the evaporator 230 bypasses the heater core 410 after passing through the blower 310, and in a heating mode, the air passing the evaporator 230 is changed into warm air while passing through the heater core 410.

After that, the air is discharged to the interior of the vehicle through the air outlet 412 opened by the mode doors 450 depending on air discharge modes in order to perform cooling or heating of the interior of the vehicle.

Meanwhile, when the blower 310 of the blower unit 300 of the air conditioner 100 operates, the air inhaled into the air inlet 220 of the evaporator unit 200 passes through the evaporator 230, and then, is supplied to the rear seat through the rear vent 440 communicating with the second outlet 260. Likewise, because the rear seat of the vehicle has a blower unit and a heater unit, the air conditioner can cool and heat the rear seat.

Moreover, referring to FIG. 5, in the conventional air conditioner, when the air introduced from the blower unit passes the evaporator and the heater core, a stepped portion is formed on the case in order to uniformly distribute the volume of air passing through the evaporator and uniformly supply the air to the heater core. However, the air conditioner 100 according to the present invention can uniformly supply air to the whole upper and lower surfaces of the heater core 410 at uniform wind speed without the stepped portion since the air passing through the evaporator 230 heads the heater core 410 after passing the blower 310. Therefore, the air conditioner 100 for a vehicle according to the present invention can enhance temperature performance, reduce noise, and improve air-conditioning performance.

The embodiments of the air conditioner for a vehicle as described above are only the example. Therefore, it will be appreciated by those skilled in the art that various modifications and equivalent other embodiments are possible from the present invention. Therefore, it may be appreciated that the present invention is not limited to the forms mentioned in the above detailed description. Accordingly, the actual technical protection scope of the present invention must be determined by the spirit of the appended claims. Further, it is to be construed that the present invention includes all the changes, equivalents, and substitutions which are defined in the appending claims.

1. An air conditioner for a vehicle comprising a cooling heat exchanger, a blower, and a heating heat exchanger,
wherein the cooling heat exchanger, the blower, and the heating heat exchanger are arranged in order in a width direction of the vehicle, and are arranged parallel with a dash panel of the vehicle, and
wherein the dash panel of the vehicle and the cooling heat exchanger are arranged parallel with each other to face each other.

2. The air conditioner according to claim 1, further comprising:
an evaporator unit having an air inlet, wherein the cooling heat exchanger is disposed therein;
a blower unit communicating with the evaporator unit and having the blower therein; and
a heater unit communicating with the blower unit and having an air outlet formed at one side thereof, wherein the heating heat exchanger is disposed therein,
wherein air introduced into the air inlet passes through the cooling heat exchanger, the blower and the heater core in order, and then, is discharged to the air outlet.

3. The air conditioner according to claim 2, wherein the air inlet comprises an indoor air inlet which is an inlet for inhaling indoor air of the vehicle and an outdoor air inlet which is an inlet for inhaling outdoor air of the vehicle, and
wherein the evaporator unit comprises an indoor and outdoor air door for selectively introducing the indoor air or the outdoor air of the vehicle.

4. The air conditioner according to claim 2, wherein a condensate water drain is disposed inside the evaporator unit in order to drain condensate water dropping from the cooling heat exchanger.

5. The air conditioner according to claim 2, wherein the blower unit is arranged between the evaporator unit and the heater unit, and
wherein a rotary shaft of the blower is arranged in a back-and-forth direction of the vehicle.

6. The air conditioner according to claim 2, wherein the heater unit comprises:
an air-conditioning case having an air passageway communicating with the air outlet;
the heating heat exchanger mounted in the air passageway of the air-conditioning case; and
a temperature-adjusting door mounted at one side of the heating heat exchanger in order to adjust the degree of opening of the passageway passing the heater core.

7. The air conditioner according to claim 2, further comprising:
a rear vent for discharging air to the rear seat of the vehicle,
wherein the evaporator unit comprises a second outlet communicating with the rear vent.

8. The air conditioner according to claim 7, wherein the second outlet is formed at a lower side of the first outlet.

9. The air conditioner according to claim 8, wherein the rear vent communicating with the second outlet is arranged at a lower side of the heater unit.

10. The air conditioner according to claim 9, wherein a rear seat door is disposed at the second outlet to open or close the second outlet.
